(19) United States
(12) Patent Application Publication
(10) Pub. No.: US 2014/0111396 A1
(43) Pub. Date: Apr. 24, 2014

(54) Dual Band Interleaved Phased Array Antenna

(71) Applicant: FutureWei Technologies, Inc., Plano, TX (US)

(72) Inventors: Fayez Hyjazie, Ottawa (CA); Paul Watson, Kanata (CA); Halim Boutayeb, Montreal (CA)

(21) Appl. No.: 13/914,046

(22) Filed: Jun. 10, 2013

Related U.S. Application Data
(60) Provisional application No. 61/716,218, filed on Oct. 19, 2012.

(51) Int. Cl. H01Q 21/30; H01Q 21/26; H01Q 1/52; H01Q 9/16

(52) U.S. Cl. CPC H01Q 21/30; H01Q 9/16; H01Q 21/26; H01Q 1/523
USPC 343/798; 343/821; 343/797; 343/893; 343/835; 343/841

(57) ABSTRACT

The height of crossed-dipoles antenna elements can be reduced by including an additional bend/segment in the feed-line and/or tuning-stub of the antenna dipole having the upper slot. The extra bend allows the crossed-dipoles antenna element to be shortened by as much as twenty percent without reducing the feed-line length. Additionally, the height of crossed-dipoles antenna elements can be reduced by shaping a winged portion of the balun-fed dipoles to match the contour of a radome contour, which allows the crossed-dipoles antenna element to accommodate a shallower radome and achieve a thinner antenna module. Additionally, the height of crossed-dipoles antenna elements can be reduced by positioning periodic structures around the base of low-band radiating elements to provide artificial magnetic conductor (AMC) functionality, which enables constructive interference between reflected and non-reflected signals at profile spacings of less than one-quarter wavelength.

This application claims the benefit of U.S. Provisional Application No. 61/716,218 filed on Oct. 19, 2012, entitled “Dual Band Interleaved Phased Array Antenna and Method,” which is incorporated herein by reference as if reproduced in its entirety.

### TECHNICAL FIELD

The present invention relates to a wireless communications antenna and method, and, in particular embodiments, to a dual band interleaved phased array antenna.

### BACKGROUND

Base station antennas are often mounted in high traffic metropolitan areas. As a result, compact antenna modules are favored over bulkier modules, as compact modules are aesthetically pleasing (e.g., less-noticeable) as well as easier to install and service. Many base station antennas deploy arrays of antenna elements to achieve advanced antenna functionality, e.g., beamforming, etc. Accordingly, techniques and architectures for reducing the profile of individual antenna elements as well as for reducing the size (e.g., width, etc.) of the antenna element arrays are desired.

### SUMMARY OF THE INVENTION

Technical advantages are generally achieved, by embodiments of this disclosure which describe dual band interleaved phased array antenna.

In accordance with an embodiment, a balun-fed dipole of a crossed-dipoles antenna element is provided. In this example, the balun-fed dipole comprises a substrate having a lower region and an upper region, a feed-line printed on a first face of the substrate, and a first conductive layer printed on the first face of the substrate. The feed-line extends at least partially across the lower region of the substrate, and the first conductive layer at least partially covers the upper region of the substrate.

In accordance with another embodiment, a crossed-dipoles antenna element is provided. In this example, the crossed-dipoles antenna element includes a first balun-fed dipole comprising a first substrate, a lower slot carved out of the first substrate, and a first feed-line printed on the first substrate. The first feed-line is routed around the lower slot. The crossed-dipoles antenna element further includes a second balun-fed dipole comprising a second substrate, an upper slot carved out of the second substrate, and a second feed-line printed on the second substrate. The second feed-line is routed beneath the upper slot. A longest segment of the first feed-line is longer than a longest segment of the second feed-line, and the second feed-line includes at least one more segment than the first feed-line.

In accordance with yet another embodiment, a base station antenna is provided. In this example, the base station antenna includes an antenna reflector, an array of crossed-dipoles antenna elements mounted to the antenna reflector, and a radome encasing the array of crossed-dipoles antenna elements. The array of crossed-dipoles antenna elements are positioned in between the radome and the antenna reflector, and an uppermost portion of at least one crossed-dipoles antenna element in the array of crossed-dipoles antenna elements conforms to a contour of the radome.

In accordance with yet another embodiment, a phased array antenna is provided. In this example, the phased antenna includes an array of low-band radiating elements, and an array of high-band radiating elements configured to radiate at a higher frequency band than the array of low-band radiating elements. The high-band radiating elements are separated from one another by a narrower spacing than the low-band radiating elements.

In accordance with yet another embodiment, a phased array antenna is provided. In this example, the phased array antenna includes an antenna reflector, a plurality of radiating elements mounted to the antenna reflector, and a periodic structures mounted around the bases of the radiating elements. The plurality of radiating elements including an array of low-band radiating elements and an array of high-band radiating elements, and the high-band radiating elements are configured to radiate at a higher frequency than the low-band radiating elements.

In accordance with yet another embodiment, a phased array antenna is provided. In this example, the phased array antenna includes an antenna reflector, a set of columns of low-band radiating elements mounted to the antenna reflector, and a set of columns of high-band radiating elements mounted to the antenna reflector. The set of columns of high-band radiating elements are interleaved with the set of columns of low-band radiating elements. The phased array antenna further includes conductive fences running vertically adjacent to the set of columns of low-band radiating elements.

In accordance with yet another embodiment, a phased array antenna is provided. In this example, the phased array antenna includes an antenna reflector, a set of columns of low-band radiating elements mounted to the antenna reflector, and a set of columns of high-band radiating elements mounted to the antenna reflector. The set of columns of high-band radiating elements are interleaved with the set of columns of low-band radiating elements. Adjacent columns in the set of high-band radiating elements are vertically offset with respect to one another.

In accordance with yet another embodiment, a balun-fed dipole of a crossed-dipoles antenna element is provided. In this example, the balun-fed dipole includes a substrate, a feed-line printed on a face of the substrate, the feed-line extending at least partially across the lower region of the substrate, and a conductive layer printed on an opposing face of the substrate. The conductive layer comprising a bottommost end that is configured to be conductively joined to a ground plane. The bottommost end is notched to reduce a surface area in contact with ground plane.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a diagram of a wireless network for communicating data;

FIG. 2 illustrates a diagram of a conventional base station antenna;

FIG. 3 illustrates a diagram of an embodiment base station antenna;

FIGS. 4A-4E illustrate diagrams of a conventional crossed-dipoles antenna element;

FIGS. 5A-5E illustrate diagrams of an embodiment crossed-dipoles antenna element;

FIG. 6 illustrates diagrams of a plurality of embodiment dipole wing shapes;

FIGS. 7A-7E illustrate diagrams of another embodiment crossed-dipoles antenna element;

FIG. 8 illustrates diagrams of embodiment arrays of radiating elements;

FIGS. 9A-9B illustrate diagrams of embodiment approaches for achieving port isolation;

FIG. 10 illustrates a graph of simulated azimuth antenna patterns;

FIG. 11 illustrates a diagram of an embodiment dual band array;

FIG. 12 illustrates a diagram of an embodiment interleaved array;

FIG. 13 illustrates a diagram of an embodiment base station antenna;

FIG. 14 illustrate a diagram of an embodiment radiating element configuration;

FIG. 15 illustrates a diagram for obtaining constructive interference in a conventional dipole configuration;

FIG. 16 illustrates a diagram for obtaining constructive interference in an embodiment dipole configuration;

FIG. 17 illustrates a diagram of a unit cell design that uses a phase of reflection coefficient;

FIG. 18 illustrates a graph of phase angle versus frequency;

FIG. 19 illustrates a diagram of a suspended micro-strip line;

FIG. 20 illustrates a diagram of a transmission coefficient of a suspended micro strip line; and

FIG. 21 illustrates a block diagram of an embodiment communications device.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Portions of this disclosure relate to crossed-dipoles antenna element architectures, which typically include a pair of balun-fed dipoles having one antenna dipole with an upper slot and another antenna dipole with a lower slot. The slots allow the respective dipoles to be mounted perpendicularly to one another by sliding the lower slot over the upper slot such that the respective slots intersect.

Aspects of this disclosure provide techniques for reducing the height of crossed-dipoles antenna elements, which may allow for thinner base station antenna modules as well as provide a larger housing for active antenna circuitry. In one embodiment, an additional bend/segment is included in the feed-line and/or tuning-stub of the antenna dipole having the upper slot to allow the length of that feed-line/tuning-stub to be maintained when the height of the crossed-dipoles antenna element is reduced. Indeed, the extra bend allows the crossed-dipoles antenna element to be shortened by as much as twenty percent without reducing the feed-line length. Another embodiment conforms the winged portion of the balun-fed dipoles to match the radome's contour, which allows the crossed-dipoles antenna element to accommodate a shallower radome and achieve a thinner antenna module. In yet another embodiment, periodic structures are positioned at the base of radiating elements to provide artificial magnetic conductor (AMC) functionality. The AMC functionality enables constructive interference between reflected and non-reflected signals to be achieved at profile spacings of less than one-quarter wavelength, thereby allowing for thinner base station antennas. The periodic structures also provide an electromagnetic band gap (EBG) function for improved isolation between radiating elements.

Additional aspects of this disclosure provide techniques for achieving improved crossed-dipoles antenna element performance. In one embodiment, improved return loss bandwidth is achieved by including an additional conductive layer above the feed-line on the winged portion of the balun-fed dipoles. In another embodiment, the bottom most edges of the conductive layer are notched to provide a more reliable conductive interconnection between the conductive layer and the ground plane.

Aspects of this disclosure also provide techniques for improving the performance of interleaved antenna arrays. One such technique utilizes non-uniform spacings between high and low-band radiating elements to increase inter-band isolation, as well as to reduce the grating lobe effect and mitigate beam-narrowing/dispersion that results from fixed element spacings. The non-uniform spacings may include wider spacings between low-band radiating elements than between high-band radiating elements. Another such technique utilizes conductive fences positioned in-between horizontally adjacent columns of radiating elements to provide increased intra-band isolation. The central fences may include voids to prevent the propagation of unwanted modes. Additionally, edge fences may be positioned on either side of the array to reduce front to back radiation.

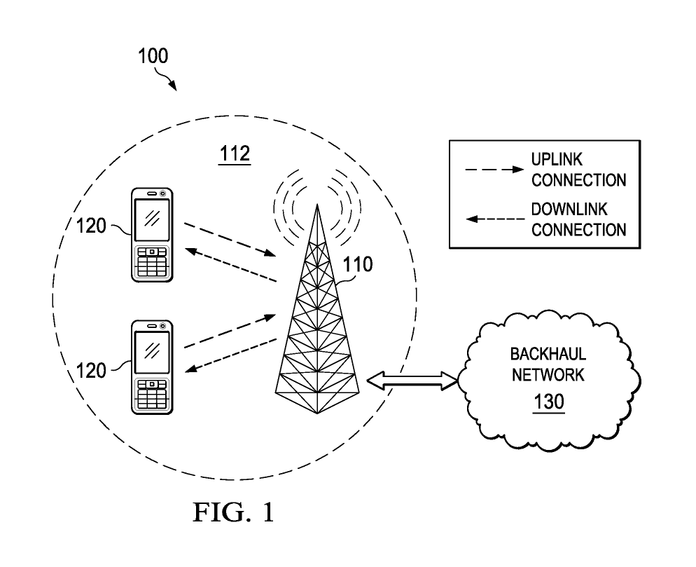

FIG. 1 illustrates a network 100 for communicating data. The network 100 comprises an access point (AP) 110 having a coverage area 112, a plurality of user equipments (UEs) 120, and a backhaul network 130. The AP 110 may comprise any component capable of providing wireless access by, inter alia, establishing uplink (dashed line) and/or downlink (dotted line) connections with the UEs 120, such as a base station, an enhanced base station (eNB), a femtocell, and other wirelessly enabled devices. The UEs 120 may comprise any component capable of establishing a wireless connection with the AP 110. The backhaul network 130 may be any component or collection of components that allow data to be exchanged between the AP 110 and a remote end (not shown). In some embodiments, the network 100 may comprise various other wireless devices, such as relays, femtocells, etc.

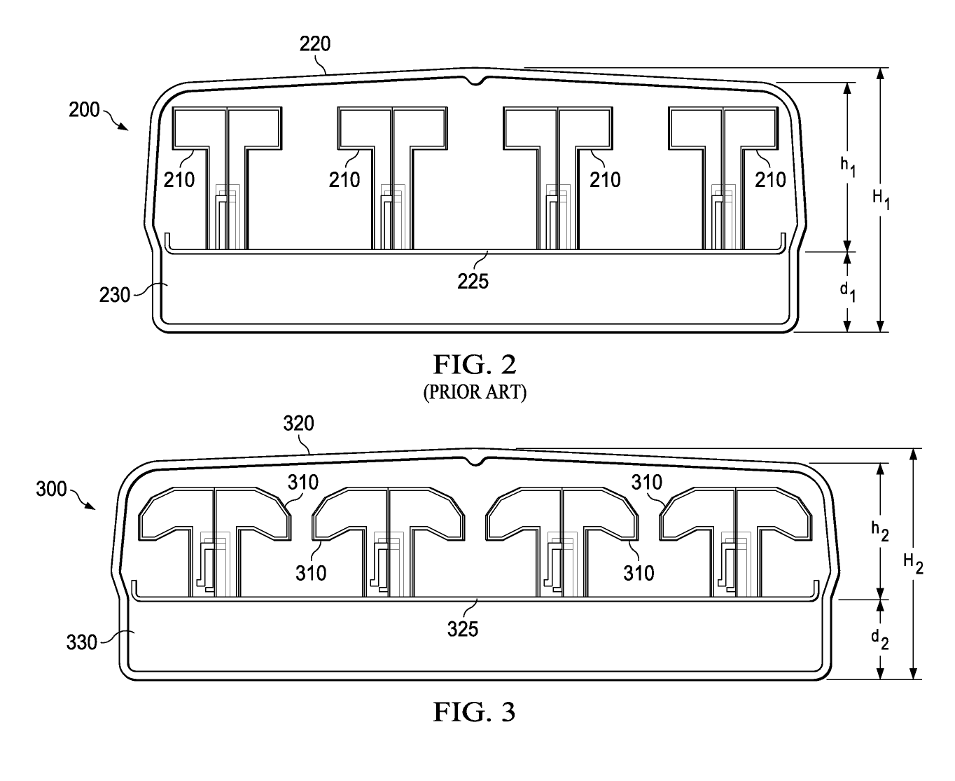

FIG. 2 illustrates a conventional base station antenna 200 for performing wireless communications. As shown, the conventional base station antenna 200 comprises crossed-dipoles antenna elements 210, a radome 220, and an antenna reflector 225. The crossed-dipoles antenna elements 210 are mounted to the antenna reflector 225, and the radome 220 encases the crossed-dipoles antenna elements 210 to shield them from the environment. The conventional base station antenna 200 further includes a compartment 230 for housing active antenna components. The height (H₁) of the conventional base station antenna 200 depends largely on the height (h₁) of the traditional crossed-dipoles antenna elements 210 as well as on the depth (d₁) of the compartment 230. Accordingly, the height (H₁) of the conventional base station antenna 200 may be reduced by either reducing the height (h₁) of the traditional crossed-dipoles antenna elements 210, or by reducing the depth (d₁) of the compartment 230. However, reducing the depth (d₁) of the compartment 230 may require implementing less-advanced active antenna components (e.g., due to space restrictions), and therefore may restrict the performance of the conventional base station antenna 200. Accordingly, techniques for reducing the height (h₁) of the traditional crossed-dipoles antenna elements 210 are desired.

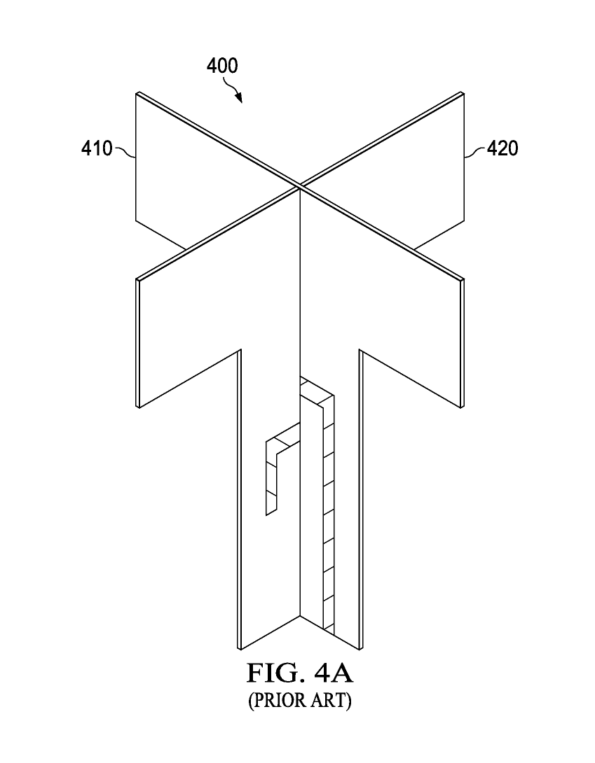

Aspects of this disclosure provide techniques for reducing the height of crossed-dipoles antennas. FIG. 3 illustrates an embodiment base station antenna 300 for performing wireless communications. As shown, the embodiment base station antenna 300 comprises embodiment crossed-dipoles antenna elements 310, a radome 320, and an antenna reflector 325. The radome 320 and the antenna reflector 325 may be configured similarly to the radome 220 and the antenna reflector 225. Further, the crossed-dipoles antenna elements 310 may radiate at similar frequencies to the crossed-dipoles antenna elements 210. However, aspects of this disclosure allow a height (h₂) of the crossed-dipoles antenna elements 310 to be less than the height (h₁) of the crossed-dipoles antenna elements 210 without significantly affecting its performance characteristics. By way of example, the crossed-dipoles antenna elements 310 may exhibit an additional bend/segment in the feed-line and/or the tuning-stub to allow the overall length of the feed-line and/or tuning-stub to be maintained after reducing the height (h₂) of the crossed-dipoles antenna elements 310. As another example, the dipole arms of the crossed-dipoles antenna elements 310 may conform to a contour of the radome 320. Aspects of this disclosure may also provide techniques for improving performance of crossed-dipoles antenna elements. For example, the crossed-dipoles antenna elements 310 may have an additional conductive layer on the feed-line side to improve return loss bandwidth.

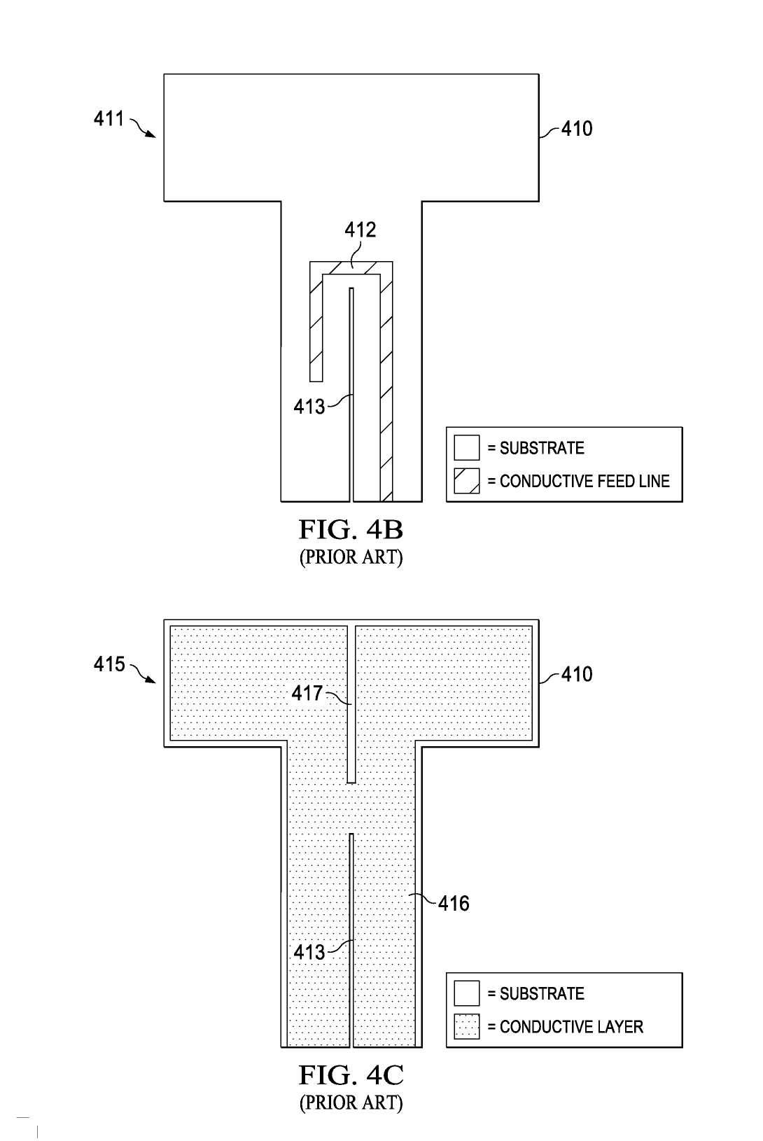

FIGS. 4A-4E illustrate a conventional crossed-dipoles antenna element 400. As shown in FIG. 4A, the conventional crossed-dipoles antenna element 400 comprises a pair of balun-fed dipoles 410, 420. As shown in FIGS. 4B-4C, a front-side 411 of the balun-fed dipole 410 includes a feed-line 412, while a rear-side 415 of the balun-fed dipole 410 includes a rear-side conductive layer 416 and a tuning-slot 417. As shown in FIGS. 4D-4E, a front-side 421 of the balun-fed dipole 420 includes a feed-line 422, while a rear-side 425 of the balun-fed dipole 420 includes a rear-side conductive layer 426 and a tuning-slot 427. The balun-fed dipole 410 comprises a lower-cut slot 413, while the balun-fed dipole 420 comprises an upper-cut slot 423. The substrate-cut slots 413, 423 allow the balun-fed dipoles 410, 420 to be joined with one another to form the crossed-dipoles antenna element 400.

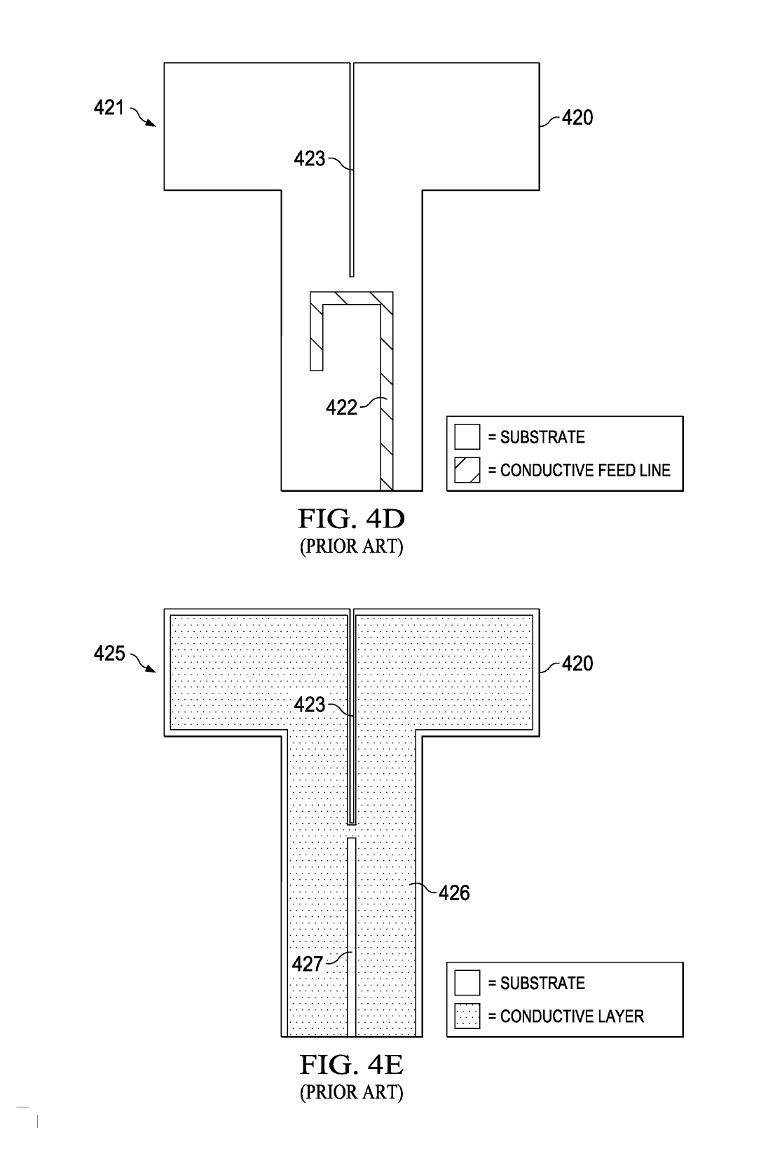

Aspects of this disclosure provide several mechanisms for reducing the height of crossed-dipoles antenna elements, such as conforming the shapes of the dipole wings to the radome, and bending the feed-line and/or tuning-stub. Another aspect of this disclosure provides an additional conductive layer on the front-side (or feed-line side) of one or both of the balun-fed dipoles to achieve improved return loss bandwidth. FIGS. 5A-5E illustrate an embodiment crossed-dipoles antenna element 500 comprising a pair of balun-fed dipoles 510, 520. Notably, the embodiment crossed-dipoles antenna element 500 is shorter than the conventional crossed-dipoles antenna element 400, while still exhibiting similar performance characteristics, e.g., radiating frequency, etc. As shown in FIG. 5A, the embodiment crossed-dipoles antenna element 500 includes front-side conductive layers 514, 524 as well as dipole wings that conform to a radome (not shown). As shown in FIGS. 5B-5C, a front-side 511 of the balun-fed dipole 510 includes a feed-line 512 and a front-side conductive layer 514, while a rear-side 515 of the balun-fed dipole 510 includes a rear-side conductive layer 516 and a tuning-slot 517. As shown in FIGS. 5D-5E, a front-side 521 of the balun-fed dipole 520 includes a feed-line 522 and a front-side conductive layer 524, while a rear-side 525 of the balun-fed dipole 520 includes a rear-side conductive layer 526 and a tuning-bent-slot 527. The balun-fed dipoles 510, 520 include substrate-cut slots 513, 523 that allow the balun-fed dipoles 510, 520 to be joined with one another to form the crossed-dipoles antenna element 500. The front-side conductive layers 514 and 524 allow the crossed-dipoles antenna element 500 to achieve improved return-loss bandwidth. Furthermore, as depicted in FIG. 5D, the feed-line 522 includes one more bend/segment than the feed-line 512, thereby allowing the feed-line 522 to have additional length without extending off the edge of the balun-fed dipole's 520 substrate. Similarly, the tuning-stub 527 includes an extra bend/segment when compared to the tuning-stub 517. To further decease the effective height of the crossed-dipoles antenna element 500, the dipole wings are conformed to match (or resemble) the contour of a radome (not shown).

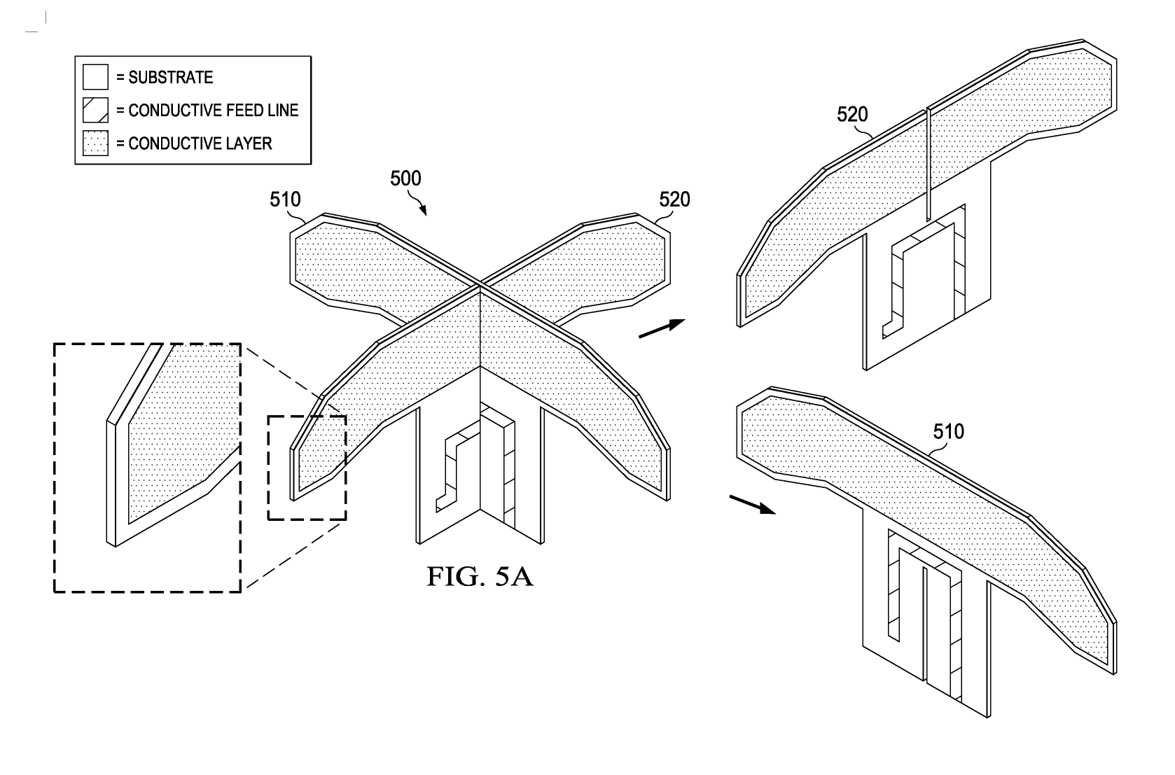

FIG. 6 illustrates a plurality of embodiment dipole wing shapes 610-690. Different dipole wing shapes may exhibit different performance characteristics. For example, a given dipole wing shape may be selected to match a termination/load of the dipole wings to the balun input. As another example, dipole wing shapes may be manipulated to widen or narrow the radiation frequency band of the base station antenna or to achieve a resonance level, e.g., single or dual resonance, etc. As another example, a dipole wing shape may be chosen to control current distribution on the dipole wing surface and/or to achieve various polarization patterns, e.g., co-polarization, cross-polarization, etc.

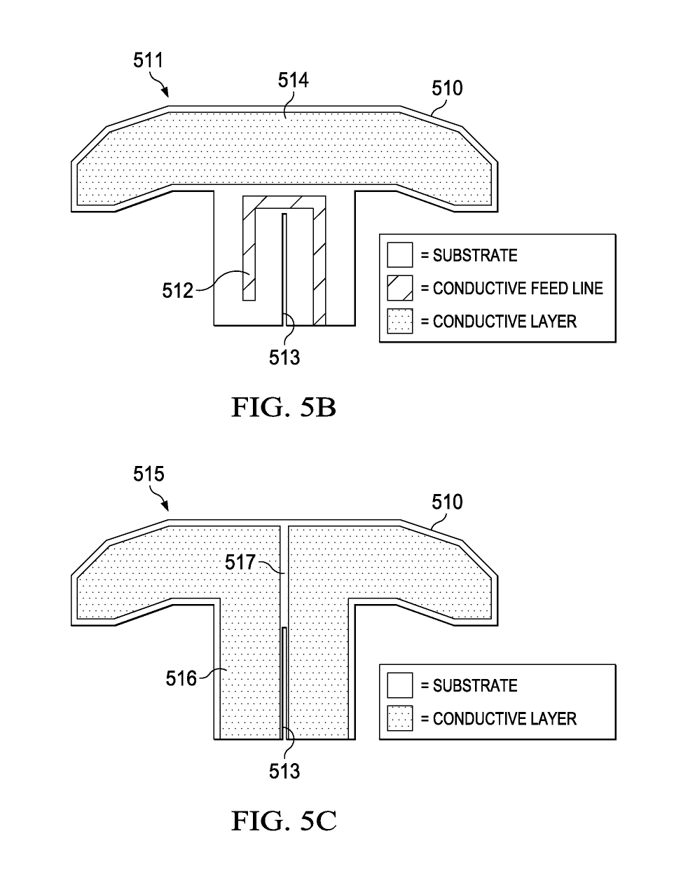

Additional aspects of this disclosure reduce the likelihood of intermodulation distortion in crossed-dipoles antenna elements by notching the ends of rear-side conductive layer. More specifically, intermodulation distortion may occur when a conductive interconnection or joint between a conductive layer and the ground plane (or antenna reflector) is non-contiguous, as may result from solder float during the manufacturing process. Aspects of this disclosure notch the bottom-most ends of the conductive layer to reduce the length (or surface area) of the conductive interconnection/joint between the conductive layer and the ground plane, thereby reducing the likelihood of conductivity gaps in that interconnection/joint. FIGS. 7A-7E illustrate an embodiment crossed-dipoles antenna element 700 that includes a pair of balun-fed dipoles 710, 720. As shown in FIGS. 7B-7C, a front-side 711 of the balun-fed dipole 710 includes a feed-line 712 and a front-side conductive layer 714, while a rear-side 715 of the balun-fed dipole 710 includes a rear-side conductive layer 716. As shown in FIGS. 7D-7E, a front-side 721 of the balun-fed dipole 720 includes a feed-line 722 and a front-side conductive layer 724, while a rear-side 725 of the balun-fed dipole 720 includes a rear-side conductive layer 726. The rear-side conductive layers 716, 726 include notched ends 718, 728 (respectively) for bonding to the ground plane.

A multiband, phased-array antenna with an interleaved tapered-element and waveguide radiators is disclosed by U.S. Pat. No. 5,557,291, which is incorporated herein by reference as if reproduced in its entirety. In an array of elements with fixed locations, the characteristics of the radiated pattern vary with frequency. For instance, the main beam narrows and grating lobes appear as the frequency increases, and if a full-bandwidth element is used, the beam narrowing can be excessive. In addition, isolation between array input ports can be achieved with a diplexer, which introduces loss as well as expense and complexity. Coupling between adjacent elements decreases antenna isolation and is an indication that the element is being perturbed, e.g., there is a degraded individual element pattern in the array environment.

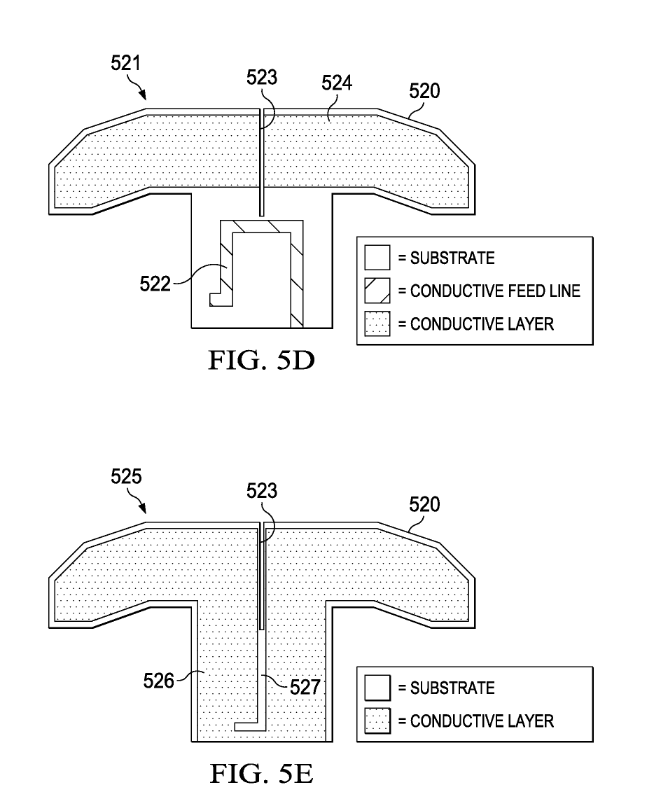

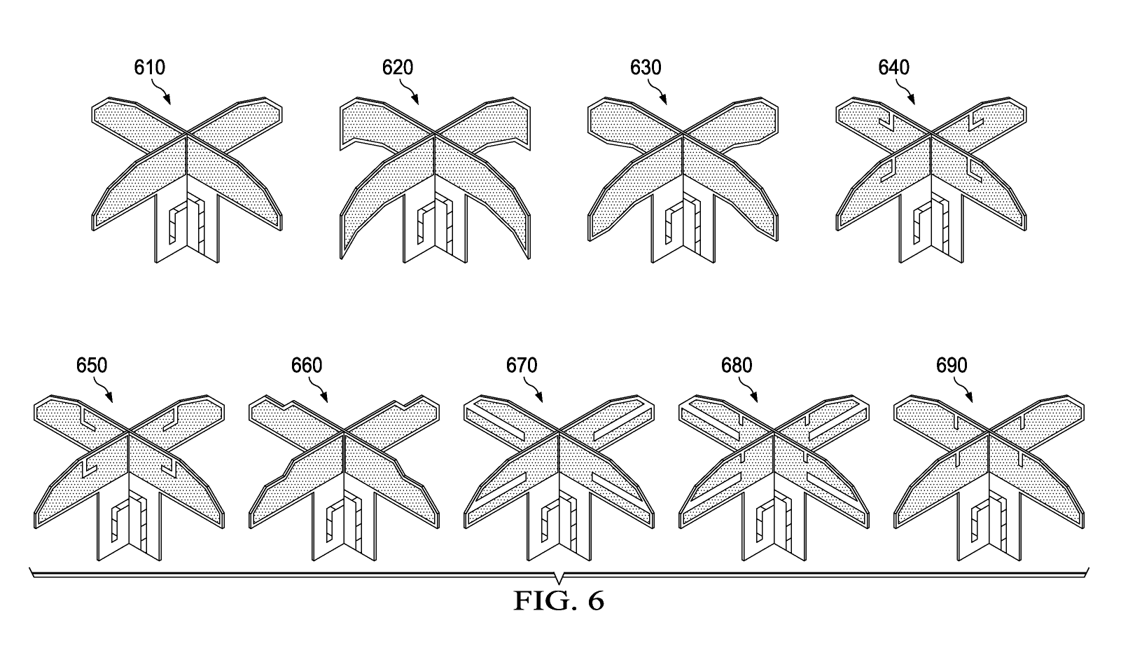

In an embodiment with two separate frequency bands, separate radiating elements are used for each band, with the respective elements being arranged with different spacings. For example, wider spacings may separate low-band elements, while narrower spacings may separate high-band elements. When compared to interleaved arrays having fixed/uniform element spacing, interleaved arrays having non-uniform element spacings may have better inter-band isolation, reduced grating lobe effects, and less beam narrowing/dispersion. FIG. 8 illustrates an embodiment interleaved array 803 and an embodiment wideband array 804. The embodiment interleaved array 803 is achieved by combining a low-band array 801 and a high-band array 802. In an embodiment, periodic structures are placed at the base of the radiating elements. The periodic structures provide an electromagnetic band gap (EBG) function for the high-band as well as an artificial magnetic conductor (AMC) function for the low-band elements. The EBG function decreases coupling between high-band elements. The AMC function allows for constructive interference between reflected and non-reflected signals at profile spacings less than one quarter wavelength. This allows the low-band elements to be lowered to achieve a reduced base station antenna thickness. Embodiments may be implemented in wireless access networks and devices, such as access points, base stations, and the like. FIGS. 9A-9B illustrate different approaches to achieve port isolation. FIG. 9A illustrates isolation for a full bandwidth element, and FIG. 9B illustrates isolation for an embodiment interleaved approach.

Embodiment dual-band interleaved array architectures may have ratios between the high-band and low-band frequencies of about 1.3:1 or 1.5:1, which is significantly less than the 2:1 ratio exhibited by conventional architectures. In various embodiments the frequency ratio may be between 2.0 and 1.9, between 1.9 and 1.8, between 1.8 and 1.7, between 1.7 and 1.6, between 1.6 and 1.5, between 1.5 and 1.4, between 1.4 and 1.3, between 1.3 and 1.2, or between 1.2 and 1.1. In other embodiments, the frequency ratio is less than one of these ratios and greater than about 1.1, greater than about 1.2, greater than 1.3, or greater than 1.4. Unlike with the frequency ratio of 2:1, which is conducive to co-locating some of the individual radiating elements of the two arrays, no individual radiating elements are co-located in various embodiments. In another embodiment, the frequency ratio is set at about 1:1, which basically is an implementation of two independent arrays on the same enclosure, which is useful for various applications.

An embodiment interleaving array provides well-controlled beam patterns that are useful in network planning and optimization, especially when operating over multiple bands. In an embodiment, inherent isolation between frequency bands relaxes or eliminates the need for multiple diplexers and the associated losses. An embodiment enables the implementation of two or more independent arrays in one enclosure. An embodiment provides small element size (droop dipoles+EBG), yielding a low-profile antenna. An embodiment provides low inter-element coupling (mutual coupling).

An embodiment uses separate elements for each of two frequency bands with independent spacings not multiples of one another, where the frequency bands are not multiple factors of one another. In one embodiment with 1800 MHz or 2100 MHz low-band and a 2690 MHz high-band, the, 2100 MHz low-band and the high-band are relatively close to one another. In an embodiment, different element spacings are used for low-band (e.g., 85 mm) and high-band (e.g., 63 mm), resulting in elements that are not co-located elements as well as an asymmetric array. This provides independent element spacing in each band. Selecting separate elements takes advantage of the isolation inherent between elements to increase the isolation between bands at the antenna input ports, thereby reducing filtering requirements.

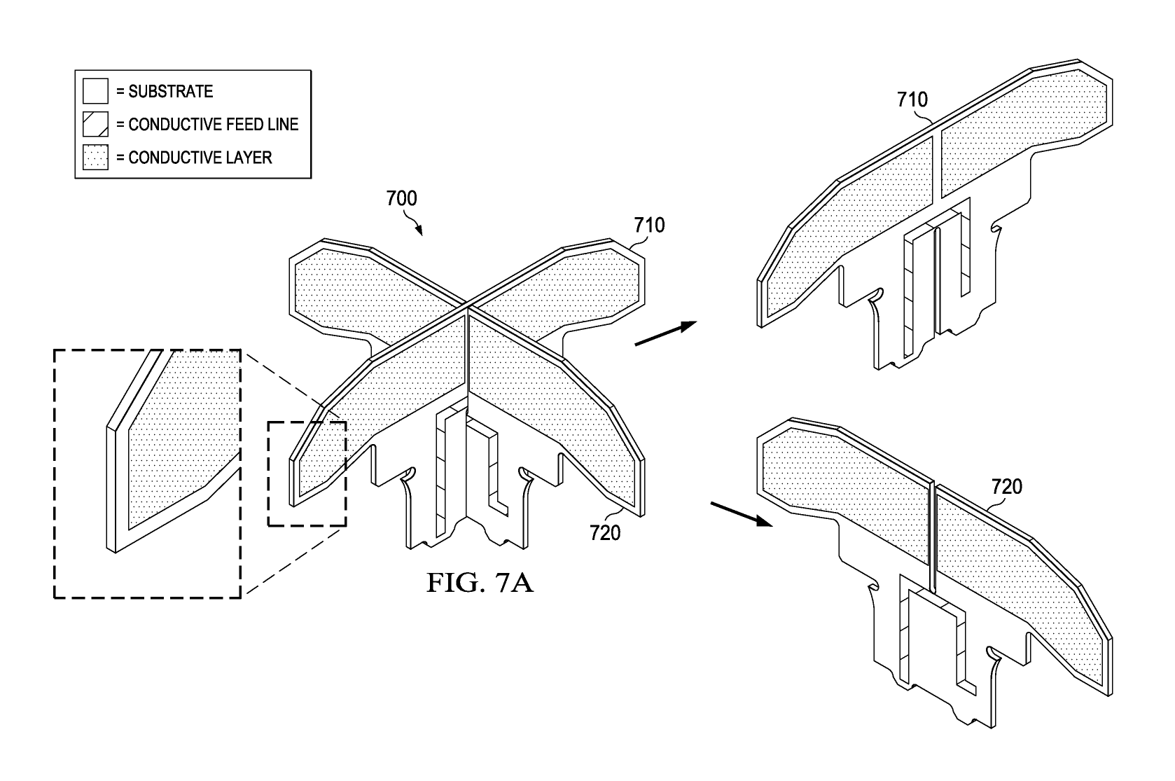

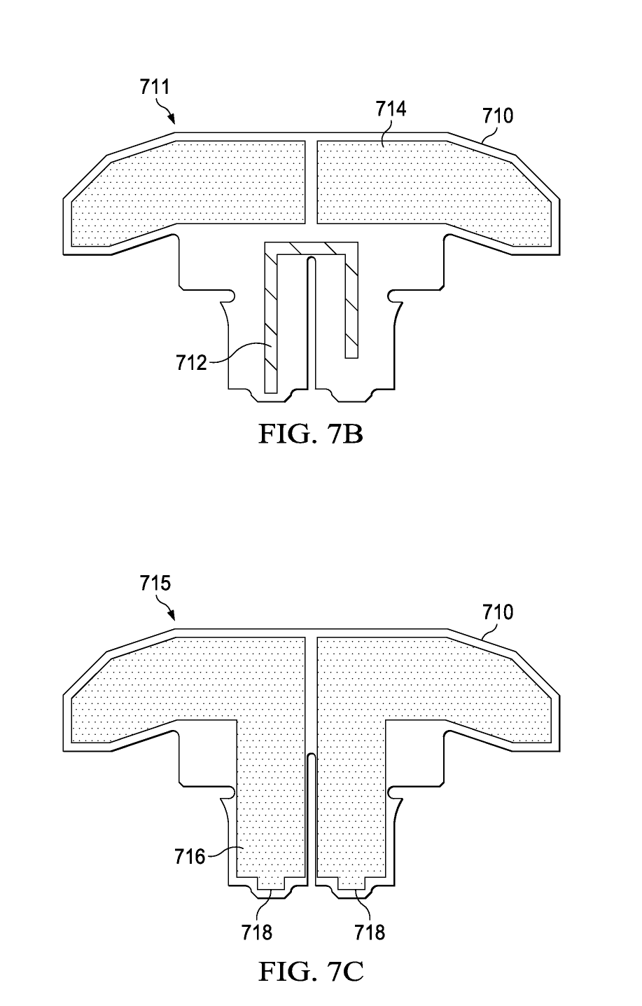

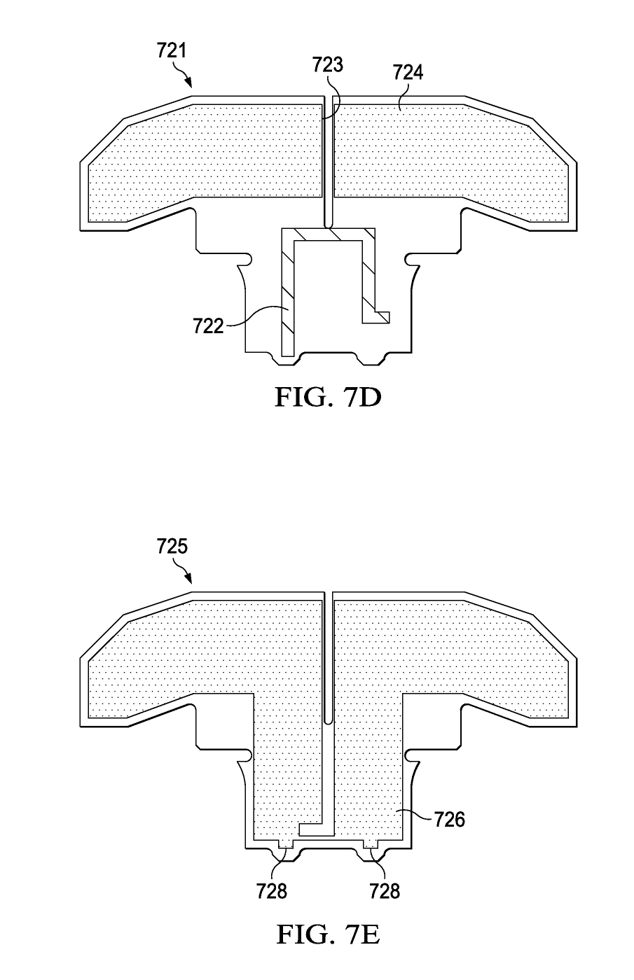

An embodiment of this disclosure limits the effects of the closely-spaced elements on adjacent elements, which includes mutual coupling as well as perturbation of the individual element patterns. An embodiment is useful for relatively closely spaced frequency bands in the same antenna, with a ratio of about 1.3:1 or 1.5:1. Embodiment dipoles and feeding baluns are more compact with a lower profile. FIG. 10 illustrates a graph of simulated azimuth antenna patterns, where an interleaved antenna avoids grating lobes and has less beam narrowing. FIG. 11 illustrates an embodiment dual band array including interleaved high and low-band radiating elements as well as a periodic structure that performs electromagnetic band gap (EBG) functionality. Low-profile dipole elements include EBG and conductive fences. A power distribution network (e.g., cables, beam forming networks, phase shifters) is located behind the reflector. The array elements have a low profile, and low mutual coupling. FIG. 12 illustrates the two interleaved arrays with 12-rows×4-columns for each array. There are eight input ports (with 50 ohms impedance).

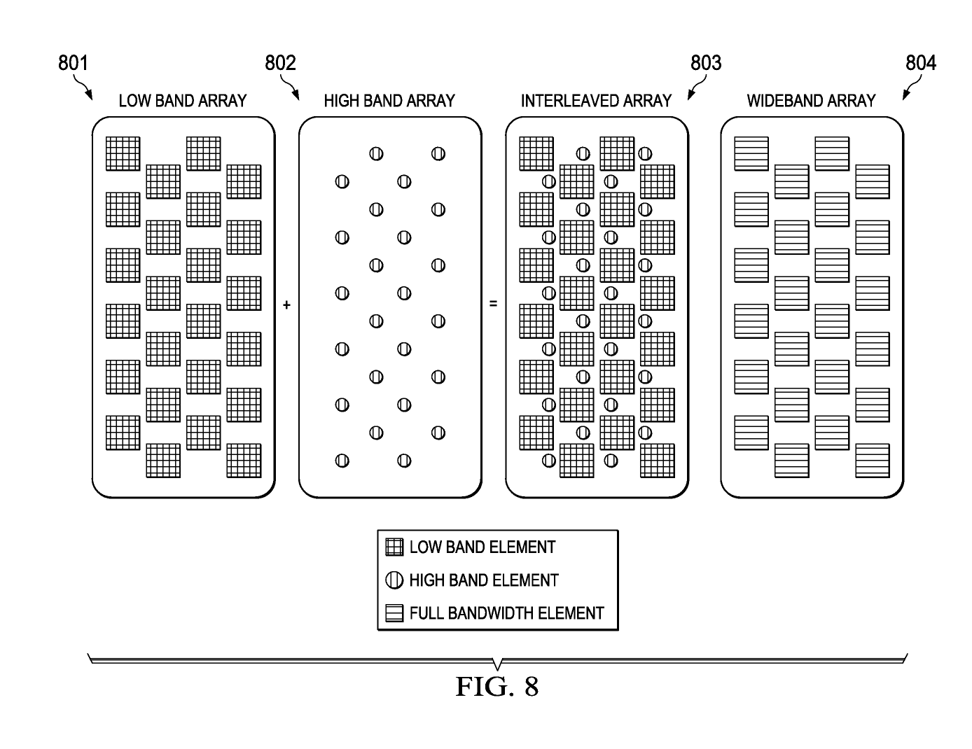

FIG. 13 illustrates a base station antenna 1300 comprising an interleaved array of low-band radiating elements 1310 and high-band radiating elements 1320 mounted on an antenna reflector 1305. The base station antenna 1300 further comprises periodic structures 1330, central conductive fences 1340, and edge fences 1350. The periodic structures 1330 are arranged around the base of the low-band radiating elements 1310 and the high-band radiating elements 1320, and are configured to provide Artificial Magnetic Conductor (AMC) functionality to the low-band radiating elements 1310 and EBG functionality to the high-band radiating elements 1320. The central conductive fences 1340 are positioned in-between columns of low-band radiating elements 1310, and are configured to reduce mutual coupling between horizontally adjacent low-band radiating elements as well as to reduce mutual coupling between horizontally adjacent high-band radiating elements. The central conductive fences 1340 include conductive segments 1341, 1342 separated by a void 1343. The void 1343 may prevent unwanted modes from propagating between the conductive segments 1341, 1342. The edge fences 1350 may run contiguously along the vertical length of the antenna reflector 1305, and may be substantially free of voids. The edge fences 1350 may prevent radiated signals from leaking behind the antenna reflector 1305.

In some embodiments, the low-band radiating elements 1310 have crossed-dipoles arms with non-uniform widths, while the high-band radiating elements 1320 may have crossed-dipole arms with uniform widths. The characteristics/properties of the periodic structures 1330 can be manipulated/selected to achieve constructive interference for different low-band element profiles. In some embodiments, the periodic structures 1330 cover the entire surface of the antenna reflector 1305. The antenna reflector 1305 may provide the ground plane. Edge fences 1350 may improve the front to back radiation ratio. Central conductive fences 1340 provide a finite number of fence segments 1341, 1342 along the reflector, and may improve the radiation pattern as well as reduce coupling between horizontally adjacent rows of elements.

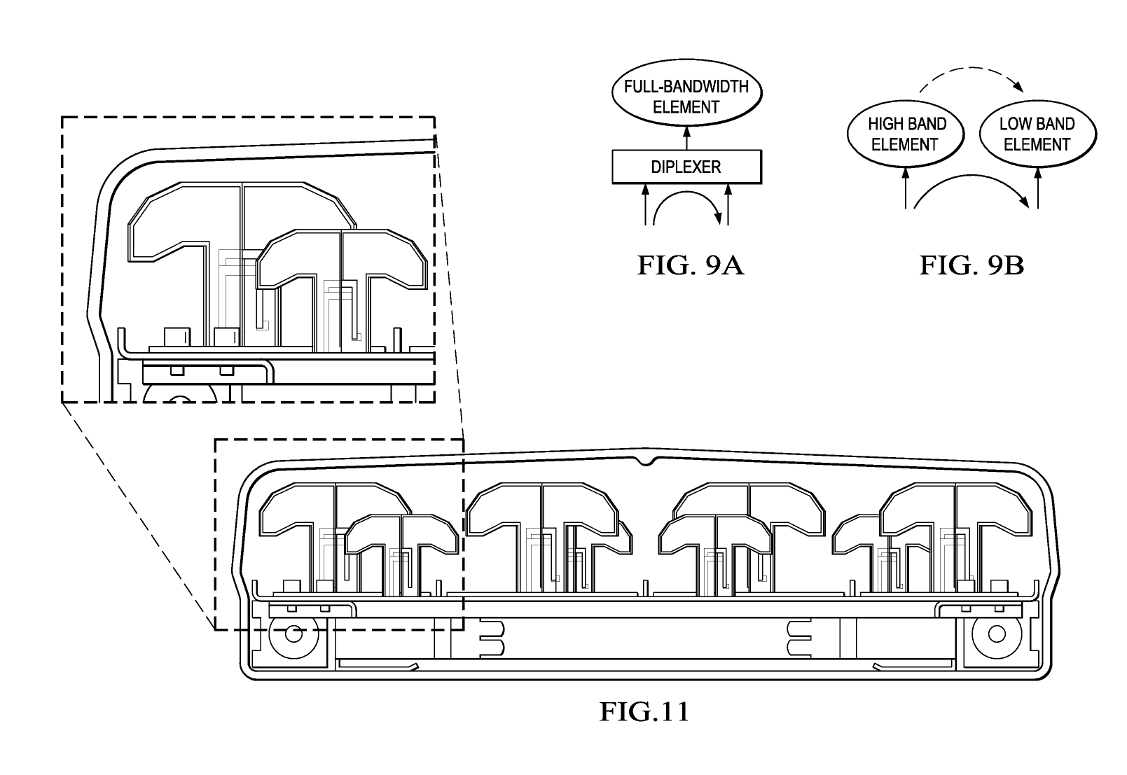

FIG. 14 illustrates a radiating element configuration 1400 comprising a plurality of periodic structures 1430 and a low-band radiating element affixed to an antenna reflector 1405. The periodic structures 1430 are positioned around the base of a low-band radiating element 1410 and are configured to provide AMC functionality by reflecting signals emitted from the low-band radiating element 1410 in a manner that causes the reflected signals to constructively interfere with the non-reflected signals. Indeed, the AMC functionality may provide constructive interference when a profile of the low-band radiating element 1410 is less than or equal to one-quarter of the low-band signal's wavelength. The term “profile” refers to a vertical separation or distance between the dipole arms and the ground plane (or antenna reflector).

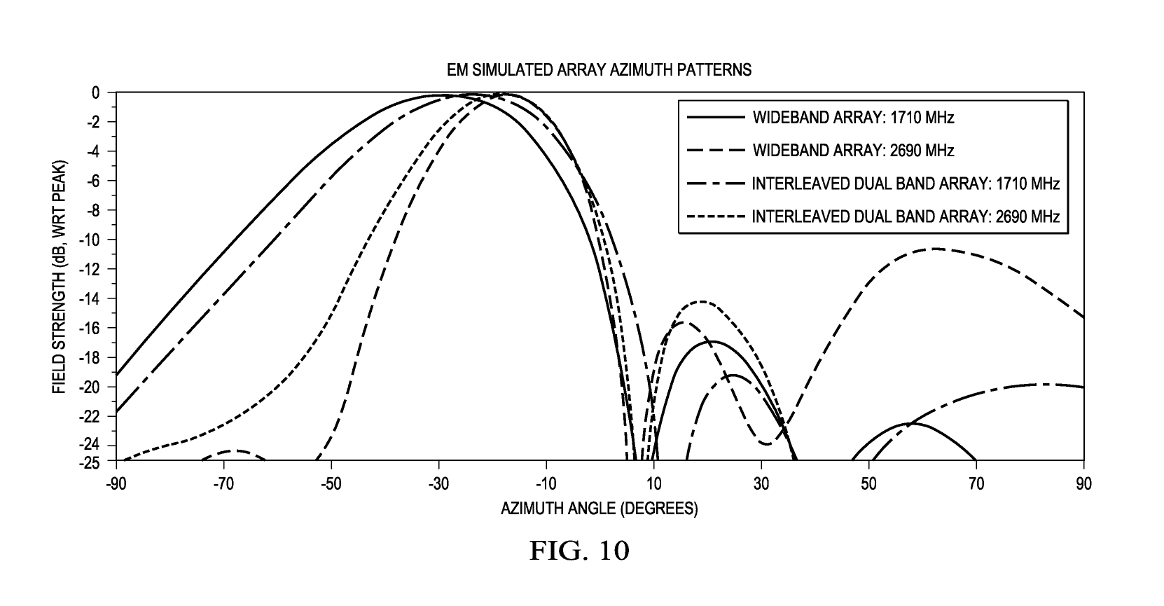

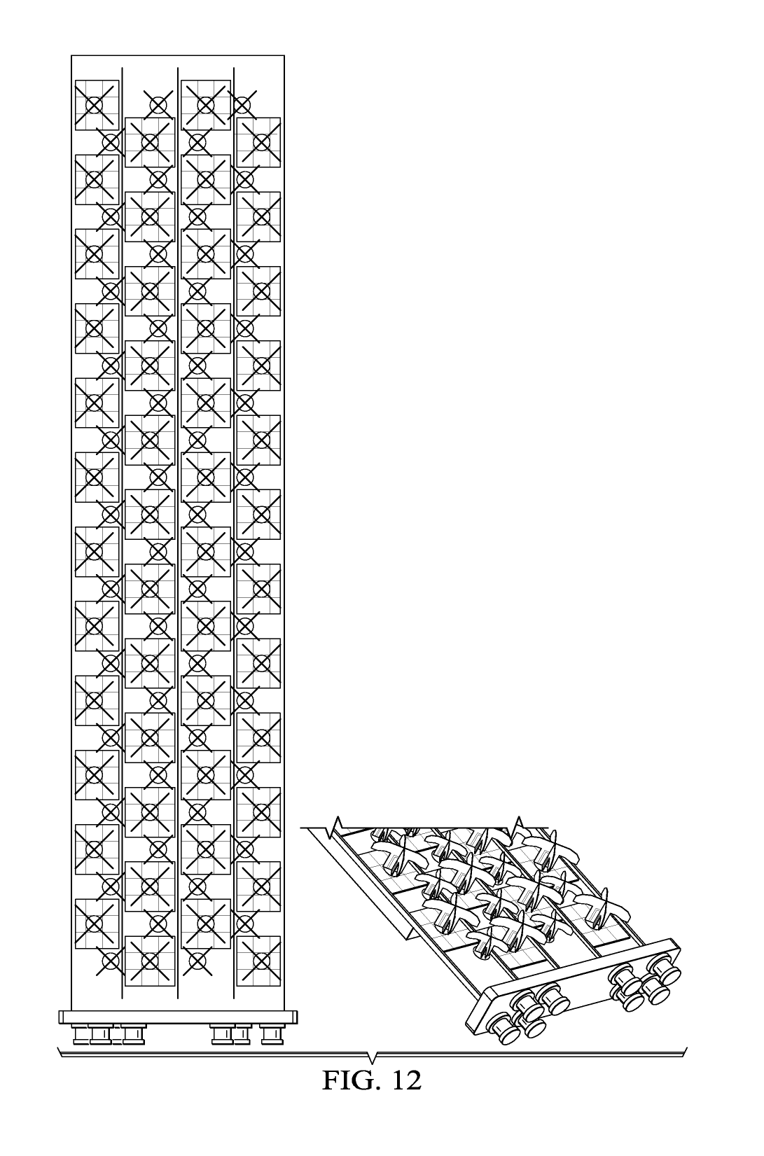

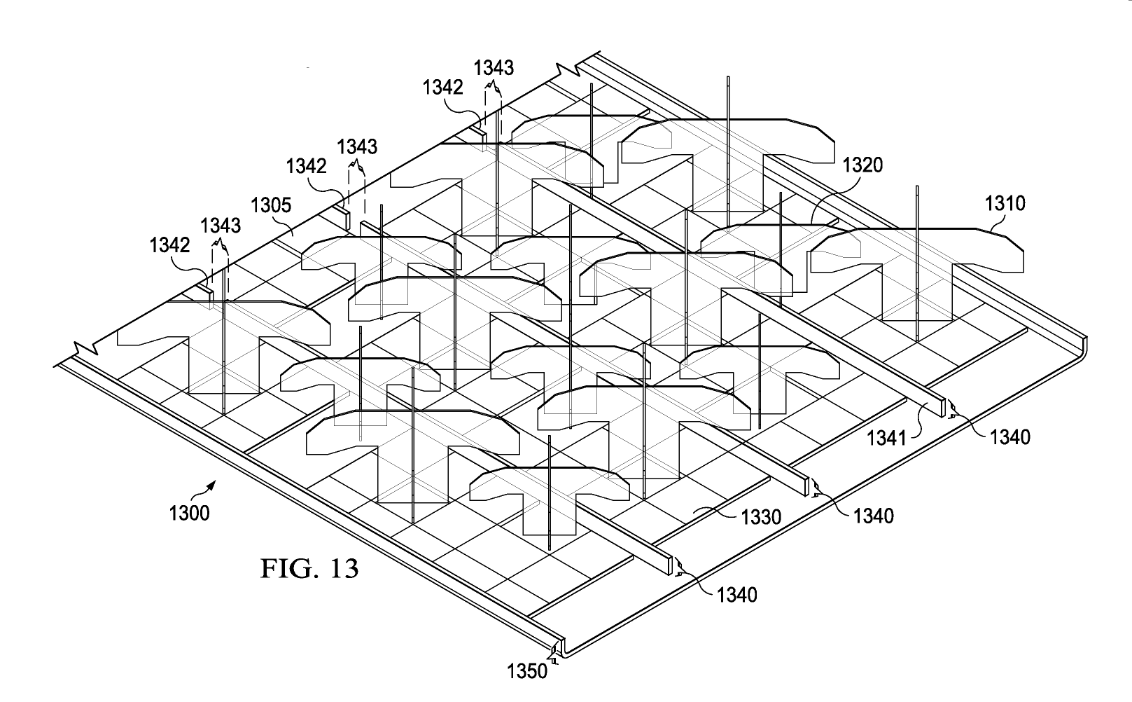

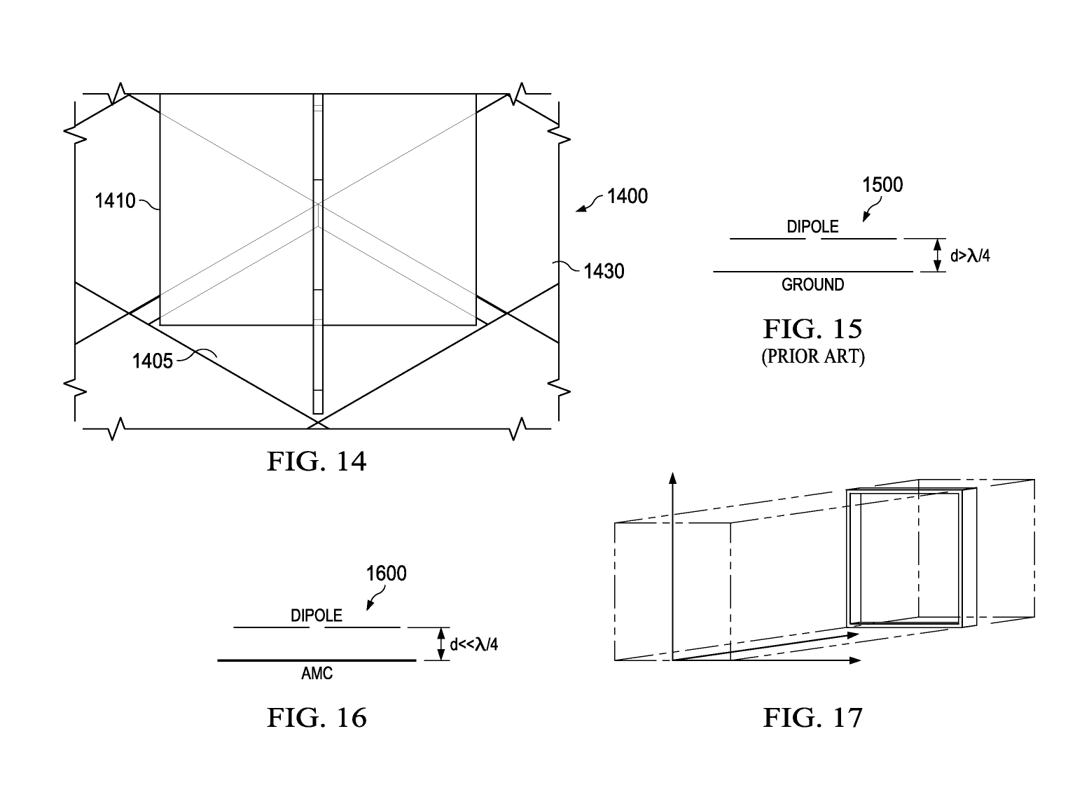

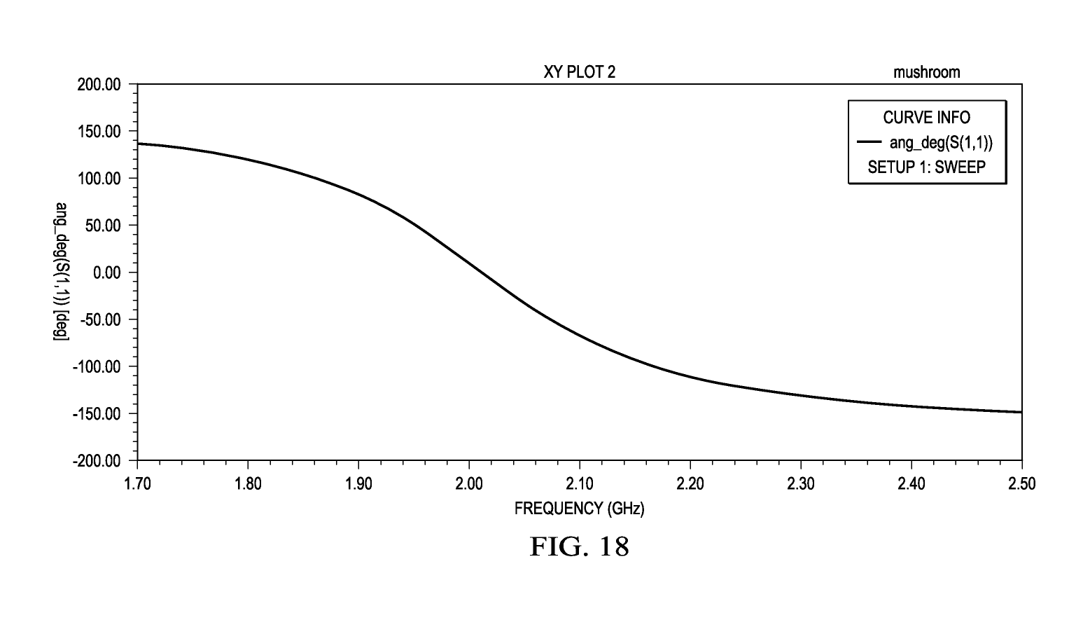

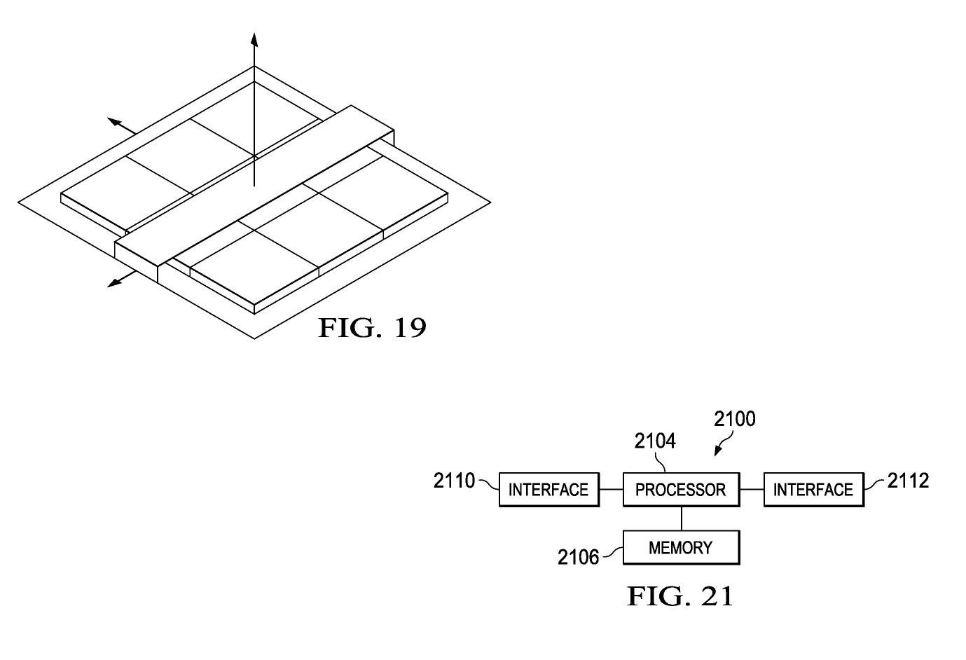

The periodic structures 1430 achieve the AMC functionality by applying a different phase shift than would otherwise have been applied by the antenna reflector. For instance, the antenna reflector may typically apply a λ/2 phase shift to reflected signals, thereby causing the reflected signals to destructively interfere with non-reflected signals when a profile is less than λ/4. Conversely, the periodic structures 1430 may apply a substantially smaller phase shift (e.g., a zero degrees phase shift) to the reflected signals, thereby providing constructive interference for profiles less than or equal to one-quarter of the low-band signal's wavelength. FIG. 15 illustrates a diagram for obtaining constructive interference in a conventional dipole configuration 1500. As shown, the conventional configuration 1501 requires a profile distance (d) between the dipole and the ground plane (e.g., an antenna reflector) in excess of λ/4 to achieve constructive interference. FIG. 16 illustrates a diagram for obtaining constructive interference in an embodiment dipole configuration 1600. As shown, the embodiment dipole configuration 1600 achieves constructive interference when a profile distance (d) is less than one-quarter wavelength. FIG. 17 illustrates a unit cell designed using a phase of reflection coefficient. FIG. 18 illustrates a graph of phase angle versus frequency. FIG. 19 illustrates a suspended micro-strip line. EBG stop-band function decreases coupling between the elements in the high frequency band. Otherwise, coupling between adjacent elements decreases antenna isolation and is an indication that the element is being perturbed (e.g., degraded individual element pattern in the array environment). FIG. 20 illustrates a transmission coefficient of a suspended micro strip line.

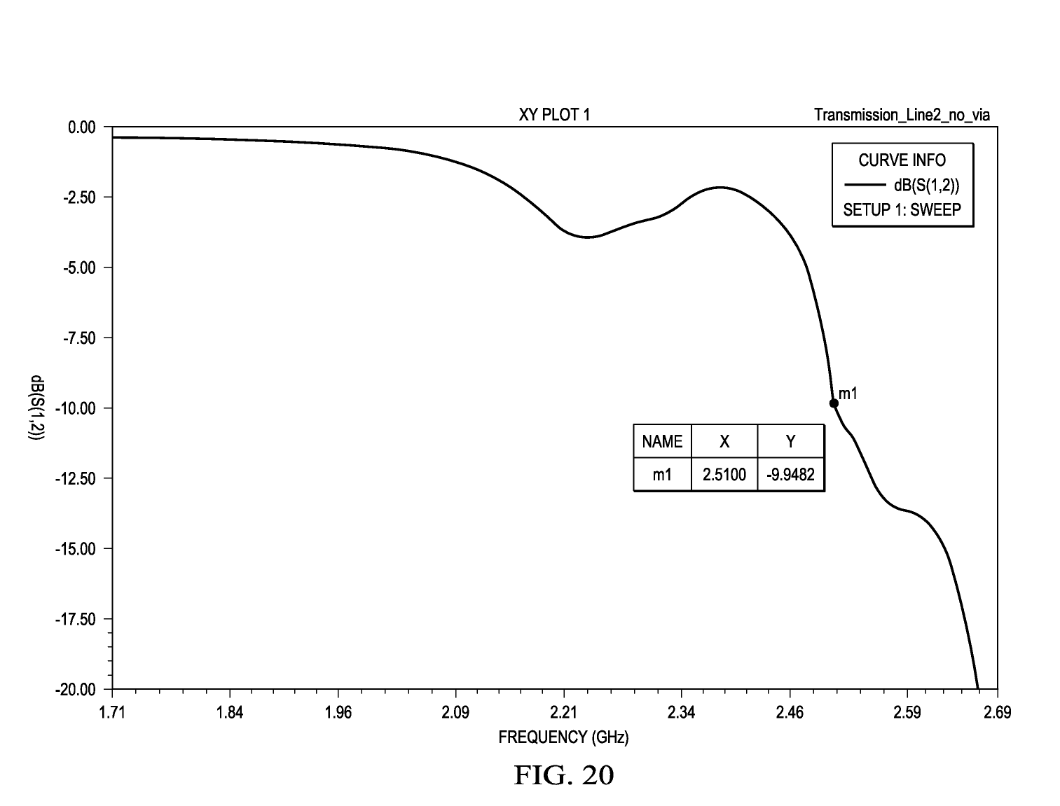

FIG. 21 illustrates a block diagram of an embodiment manufacturing device 2100, which may be used to perform one or more aspects of this disclosure. The manufacturing device 2100 includes a processor 2104, a memory 2106, and a plurality of interfaces 2110-2112, which may (or may not) be arranged as shown in FIG. 21. The processor 2104 may be any component capable of performing computations and/or other processing related tasks, and the memory 2106 may be any component capable of storing programming and/or instructions for the processor 2104. The interface 2110-2112 may be any component or collection of components that allows the device 2100 to communicate control instructions to other devices, as may be common in a factory setting.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A balun-fed dipole of a crossed-dipoles antenna element, the balun-fed dipole comprising:
a substrate comprising a lower region and an upper region, wherein the lower region is positioned below the upper region;
a feed-line printed on a first face of the substrate, the feed-line extending at least partially across the lower region of the substrate; and
a first conductive layer printed on the first face of the substrate, the first conductive layer at least partially covering the upper region of the substrate.

2. The balun-fed dipole of claim 1, further comprising a second conductive layer printed on a second face of the substrate, wherein the second face of the substrate opposes the first face of the substrate.

3. The balun-fed dipole of claim 1, wherein the first conductive layer is positioned above the feed-line on the first face of the substrate.

4. A crossed-dipoles antenna element comprising:
a first balun-fed dipole comprising a first substrate, a lower slot carved out of the first substrate, and a first feed-line printed on the first substrate, the first feed-line being routed around the lower slot; and
a second balun-fed dipole comprising a second substrate, an upper slot carved out of the second substrate, and a second feed-line printed on the second substrate, wherein the second feed-line is routed beneath the upper slot,
wherein a longest segment of the first feed-line is longer than a longest segment of the second feed-line, and
wherein the second feed-line includes at least one more segment than the first feed-line.

5. The crossed-dipoles antenna element of claim 4, wherein the at least one more segment causes the second feed-line to have approximately the same length as the first feed-line.

6. The crossed-dipoles antenna element of claim 4, wherein the first balun-fed dipole is configured to be mounted to the second first balun-fed dipole by sliding the upper slot onto the lower slot.

7. The crossed-dipoles antenna element of claim 4, wherein the first balun-fed dipole further comprises a first tuning-stub,
wherein the second balun-fed dipole further comprises a second tuning-stub, wherein a longest segment of the first tuning-stub is longer than a longest segment of the second tuning-stub, and
wherein the second tuning-stub includes at least one more segment than the first tuning-stub, the at least one additional segment causing the second tuning-stub to have approximately the same length as the first tuning-stub.

8. The crossed-dipoles antenna element of claim 7, wherein the first tuning-stub is straight.

9. The crossed-dipoles antenna element of claim 7, wherein the first balun-fed dipole further comprises a first conductive layer printed on an opposing side of the first substrate, wherein the first tuning-stub is etched out of the first conductive layer, and
wherein the second crossed-dipoles balun further comprises a second conductive layer printed on an opposing side of the second substrate, wherein the second tuning-stub is etched out of the second conductive layer.

10. A base station antenna comprising:
an antenna reflector;
an array of crossed-dipoles antenna elements mounted to the antenna reflector; and
a radome encasing the array of crossed-dipoles antenna elements, wherein the array of crossed-dipoles antenna elements are positioned in between the radome and the antenna reflector, and
wherein an uppermost portion of at least one crossed-dipoles antenna element in the array of crossed-dipoles antenna elements conforms to a contour of the radome.

11. The base station antenna of claim 10, wherein an outermost edge of the uppermost portion of the at least one crossed-dipoles antenna is rounded to conform to the contour of the radome.

12. The base station antenna of claim 10, further comprising a compartment for housing active antenna components, the compartment being positioned below the antenna reflector.

13. A phased array antenna comprising:
an array of low-band radiating elements; and
an array of high-band radiating elements configured to radiate at a higher frequency band than the array of low-band radiating elements, wherein the high-band radiating elements are separated from one another by a narrower spacing than the low-band radiating elements.

14. The phased array antenna of claim 13, wherein a ratio of radiating frequencies between the high-band radiating elements and the low-band radiating elements is between about 1.9:1 and about 1:1.

15. The phased array antenna of claim 13, wherein the ratio of radiating frequencies between the high-band radiating elements and the low-band radiating elements is about 1.3:1.

16. A phased array antenna comprising:
an antenna reflector;
a plurality of radiating elements mounted to the antenna reflector, the plurality of radiating elements including an array of low-band radiating elements and an array of high-band radiating elements, wherein the high-band radiating elements are configured to radiate at a higher frequency than the low-band radiating elements; and
periodic structures mounted to the antenna reflector, the periodic structures being positioned around the bases of the radiating elements.

17. The phased array antenna of claim 16, wherein the periodic structures include a first set of periodic structures positioned around the bases of the high-band radiating elements, the first set of periodic structures being configured to reduce mutual coupling between adjacent high-band radiating elements by providing an Electromagnetic Band Gap (EBG) between adjacent high-band elements.

18. The phased array antenna of claim 17, wherein the periodic structures further comprise a second set of periodic structures positioned around the bases of the low-band radiating elements, the second set of periodic structures being configured to provide Artificial Magnetic Conductor (AMCs) functionality.

19. The phased array antenna of claim 18, wherein the second set of structures provide AMC functionality by reflecting signals in a manner that causes the reflected signals to constructively interfere with non-reflected signals when a profile of the low-band radiating element is less than or equal to one-quarter of a wavelength emitted by the low-band radiating elements.

20. The phased array antenna of claim 19, wherein the low-band radiating elements comprise dipole arms, and wherein the profile of the low-band radiating elements corresponds to a vertical separation between the dipole arms and the antenna reflector.

21. A phased array antenna comprising:
an antenna reflector;
a set of columns of low-band radiating elements mounted to the antenna reflector;
a set of columns of high-band radiating elements mounted to the antenna reflector, wherein the set of columns of high-band radiating elements are interleaved with the set of columns of low-band radiating elements; and
conductive fences running vertically adjacent to the set of columns of low-band radiating elements.

22. The phased array antenna of claim 21, wherein the conductive fences comprise central conductive fences positioned in-between adjacent columns in the set of columns of low-band radiating elements.

23. The phased array antenna of claim 22, wherein the central conductive fences are configured to reduce low-band interference by at least partially isolating horizontally adjacent low-band radiating elements from one another.

24. The phased array antenna of claim 22, wherein the central conductive fences are further positioned in-between adjacent columns in the set of columns of high-band radiating elements, and wherein the conductive fences are configured to reduce high-band interference by at least partially isolating horizontally adjacent high-band radiating elements from one another.

25. The phased array antenna of claim 22, wherein the central conductive fences comprise a plurality of conductive segments separated by voids, the voids at least partially isolating adjacent conductive segments from one another.

26. The phased array antenna of claim 25, wherein the conductive segments have a length that is equal to about 1.6 times the radiating frequency of the low-band radiating elements.

27. The phased array antenna of claim 25, wherein the voids are configured to prevent at least some modes from propagating between adjacent conductive segments.

28. The phased array antenna of claim 25, wherein the conductive fences further comprise edge fences positioned outside the outermost columns in the set of columns of low-band radiating elements, and wherein each of the edge fences comprise a continuous conductive segment that excludes voids.

29. A phased array antenna comprising:
an antenna reflector;
a set of columns of low-band radiating elements mounted to the antenna reflector; and
a set of columns of high-band radiating elements mounted to the antenna reflector, wherein the set of columns of high-band radiating elements are interleaved with the set of columns of low-band radiating elements, and
wherein adjacent columns in the set of high-band radiating elements are vertically offset with respect to one another.

30. The phased array antenna of claim 29, wherein the vertical offset increases a separation between horizontally adjacent high-band radiating elements.

31. The phased array antenna of claim 29, wherein adjacent columns in the set of low-band radiating elements are vertically offset with respect to one another, and wherein the vertical offset between adjacent columns in the set of low-band radiating elements increases a separation between horizontally adjacent low-band radiating elements.

32. A balun-fed dipole of a crossed-dipoles antenna element, the balun-fed dipole comprising:
a substrate;
a feed-line printed on a face of the substrate, the feed-line extending at least partially across the lower region of the substrate; and
a conductive layer printed on an opposing face of the substrate, the conductive layer comprising a bottommost end that is configured to be conductively joined to a ground plane, wherein the bottommost end is notched to reduce a surface area in contact with ground plane.

33. The balun-fed dipole of claim 32, wherein at least some portion of the bottommost end has been removed to reduce the surface area in contact with the ground plane.

34. The balun-fed dipole of claim 32, wherein the bottommost end is notched to reduce a likelihood of intermodulation distortion.
